(19) United States
(12) Patent Application Publication
(10) Pub. No.: US 2015/0156329 A1
(43) Pub. Date: Jun. 4, 2015

(54) COMMUNICATIONS DEVICE, VOLUME ADJUSTING SYSTEM AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-YUAN YANG, New Taipei (TW); QING-LIANG GUO, Shenzhen (CN)

(21) Appl. No.: 14/541,775

(22) Filed: Nov. 14, 2014

(30) Foreign Application Priority Data
Nov. 30, 2013 (CN) 201310621999.7

(51) Int. Cl. H04M 9/08

(52) U.S. Cl. CPC H04M 9/08

(57) ABSTRACT

The disclosed subject matter provides a communications device, a volume adjusting system and method. The communications device includes a loudspeaker, a microphone, and a communication unit. The communications device communicates with other communications devices via the communication unit. The communications device detects a first sound intensity of sound signals collected by the microphone, and detects a second sound intensity of sound signals received by the communication unit from the other communications devices. The communications device further adjusts the sound signals received by the communication unit according to a comparison result of the first sound intensity and the second sound intensity, and outputs the adjusted sound signals via the loudspeaker.

### CROSS-REFERENCE TO RELATED APPLICATIONS

This application claims priority to Chinese Patent Application No. 201310621999.7 filed on Nov. 30, 2013, the contents of which are incorporated by reference herein.

### FIELD

The subject matter herein generally relates to communications devices, and particularly to a communications device having a volume adjusting system and method.

### BACKGROUND

When talking on a cell phone, a user of the cell phone cannot hear the other party clearly if the environment is noisy.

### BRIEF DESCRIPTION OF THE DRAWINGS

Implementations of the present technology will now be described, by way of example only, with reference to the attached figures.

FIG. 1 is a block diagram illustrating an example embodiment of a communications device having a volume adjusting system.

FIG. 2 is a flow chart illustrating an example embodiment of a volume adjusting method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout disclosure will now be presented. The term “module” refers to logic embodied in computing or firmware, or to a collection of software instruction, written in a programming language, such as Java, C, or assembly. One or more software instruction in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”, it specifically indicates open-ended inclusion or membership in a so-described combination, group, series and the like.

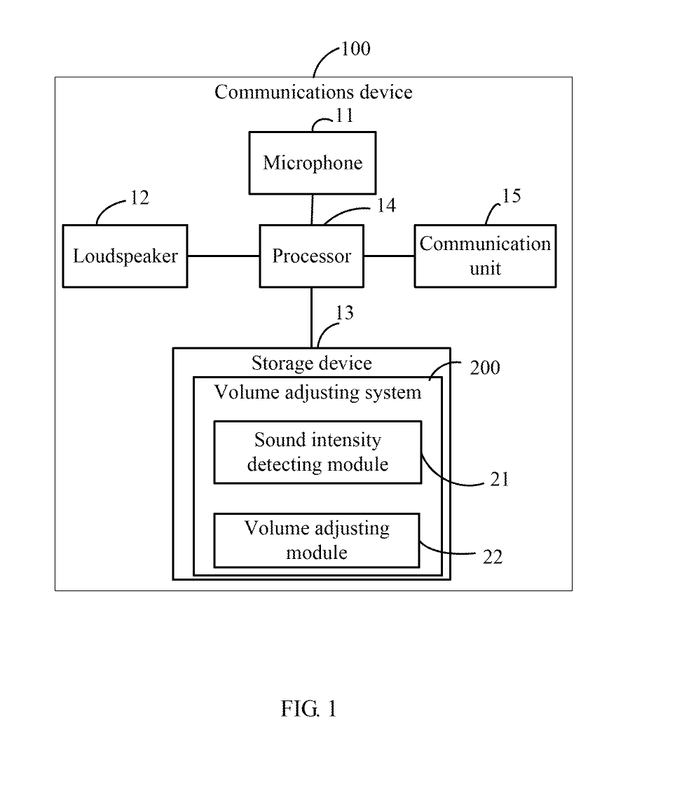

FIG. 1 illustrates a block diagram of a communications device 100. The communications device 100 can be a mobile phone, a personal computer, and the like. In at least one embodiment, the communications device 100 can include a microphone 11, a loudspeaker 12, a storage device 13, a processor 14, and a communication unit 15. The communications device 100 can establish a speech communication with other communications devices via the communication unit 15. The microphone 11 can collect sound signals of users. The loudspeaker 12 can output sound signals received by the communication unit 15 from the other communications devices.

In one embodiment, the processor 14 can be a central processing unit, a digital signal processor, or a single chip, for example. The storage device 13 is coupled to the processor 14. The storage device 13 can be an internal storage system, such as a flash memory, a random access memory (RAM) for temporary storage of information, and/or a read-only memory (ROM) for permanent storage of information. The storage device 13 can also be a storage system, such as a hard disk, a storage card, or a data storage medium. The storage device 13 can include volatile and/or non-volatile storage devices. In at least one embodiment, the storage device 13 can include two or more storage devices such that one storage device is a memory and the other storage device is a hard drive. Additionally, one or more of the storage devices 13 can be located either entirely or partially external relative to the communications device 100.

In this embodiment, a volume adjusting system 200 can be stored in the storage device 13. The volume adjusting system 200 can include a number of modules, which are collection of software instructions stored in the storage device 13 and executed by the processor 14. In at least one embodiment, the volume adjusting system 200 can include a sound intensity detecting module 21 and a volume adjusting module 22.

When the communications device 100 establishes a speech communication with other communications devices, the sound intensity detecting module 21 can detect a first sound intensity of sound signals collected by the microphone 11. The sound intensity detecting module 21 further can detect a second sound intensity of sound signals received by the communication unit 15 from the other communications devices 15. In this embodiment, the sound intensity detecting module 21 detects the sound intensity of the sound signals can use a well known technology, such as use an electroacoustic tester JH6170RH.

The volume adjusting module 22 can compare the first sound intensity of the sound signals received by the microphone 11 with the second sound intensity of the sound signals received by the communication unit 15, and adjust the volume of the sound signals received by the communication unit 15 according to a comparison result of the first sound intensity and the second sound intensity.

In detail, if the volume adjusting module 22 determines that the second sound intensity of the sound signals received by the communication unit 15 is less than the first sound intensity of the sound signals received by the microphone 11, the volume adjusting module 22 increases the volume of the sound signals received by the communication unit 15 to a first preset value which is greater than or equal to the first sound intensity of the sound signals received by the microphone 11. If the volume adjusting module 22 determines that the second sound intensity of the sound signals received by the communication unit 15 is greater than the first sound intensity of the sound signals received by the microphone 11, the volume adjusting module 22 decreases the volume of the sound signals received by the communication unit 15 to a second preset value which is equal to or less than the first sound intensity of the sound signals received by the microphone 11. It can be understood that the first preset value can be equal to the second preset value, and the first preset value further can be different from the second preset value.

The volume adjusting module 22 further can output the adjusted sound signals received by the communication unit 15 via the loudspeaker 12.

In this embodiment, it can be understood that the communications device 100 can adjust the volume of the sound signals received from the other communications devices according to the sound intensity of the sound of the user, thus the user of the communications device 100 can clearly hear the sound of the other party no matter in what environments.

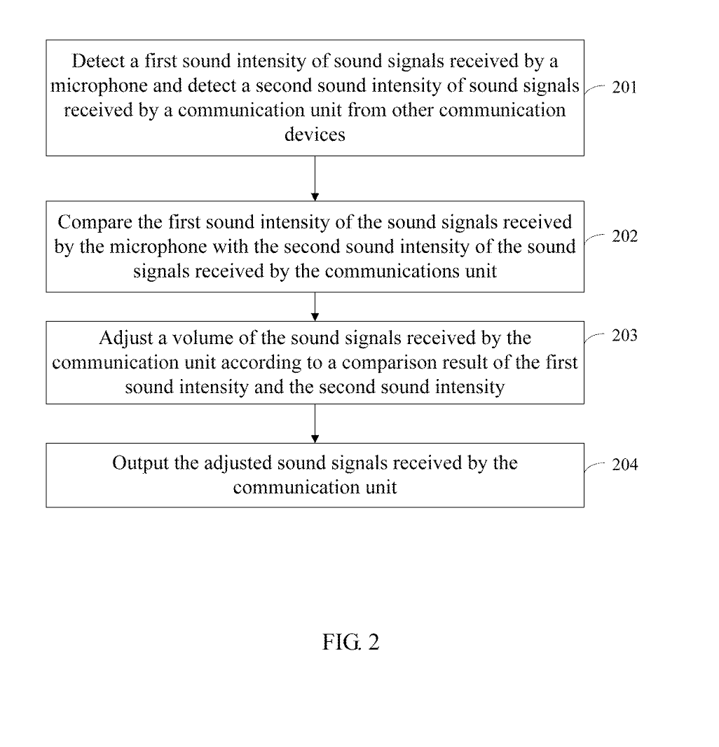

FIG. 2 illustrates an embodiment of a volume adjusting method applied in a communications device. The method is provided by way of example, as there are a variety of ways to carry out the method. The method described below can be carried out using the configurations illustrated in FIG, 1, for example, and various elements of these figures are referenced in explaining the example method. Each block shown in FIG, 2 represents one or more processes, methods, or subroutines carried out in the example method. Additionally, the illustrated order of blocks is by example only and the order of the blocks can be changed.

The example method can begin at block 201.

At block 201, when a communications device establishes a speech communication with other communications devices, a sound intensity detecting module detects a first sound intensity of sound signals received by a microphone of the communications device and detects a second sound intensity of sound signals received by a communication unit from the other communications devices communicated with the communications device.

At block 202, a volume adjusting module compares the first sound intensity of the sound signals received by the microphone with the second sound intensity of the sound signals received by the communication unit.

At block 203, the volume adjusting module adjusts a volume of the sound signals received by the communication unit according to a comparison result of the first sound intensity and the second sound intensity. In detail, if the volume adjusting module determines that the second sound intensity of the sound signals received by the communication unit is less than the first sound intensity of the sound signals received by the microphone, the volume adjusting module increases the volume of the sound signals received by the communication unit to a first preset value which is greater than or equal to the first sound intensity of the sound signals received by the microphone. If the volume adjusting module determines that the second sound intensity of the sound signals received by the communication unit is greater than the first sound intensity of the sound signals received by the microphone, the volume adjusting module decreases the volume of the sound signals received by the communication unit to a second preset value which is less than or equal to the first sound intensity of the sound signals received by the microphone.

At block 204, the volume adjusting module outputs the adjusted sound signals received by the communication unit via a loudspeaker.

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A communications device comprising:
a microphone;
a communications unit configured for signal communication with at least one other communications device;
a loudspeaker;
a processor;
a storage device coupled to the processor;
a sound intensity detecting module, stored in the storage device, comprising at least one instruction configured to cause the processor to detect a first sound intensity of sound signals collected by the microphone, and detect a second sound intensity of sound signals received by the communication unit when a speech communication is established between the communications device and the at least one other communications device; and
a volume adjusting module, stored in the storage device, comprising at least one instruction configured to cause the processor to compare the first sound intensity of the sound signals collected by the microphone and the second sound intensity of the sound signals received by the communication unit, adjust a volume of the sound signals received by the communication unit according to a comparison result of the first sound intensity and the second sound intensity, and output the sound signals after adjustment of same by the processor via the loudspeaker.

2. The communications device of claim 1, wherein if the volume adjusting module determines that the second sound intensity of the sound signals received by the communication unit is less than the first sound intensity of the sound signals received by the microphone, the volume adjusting module increases the volume of the sound signals received by the communication unit to a first preset value which is greater than or equal to the first sound intensity of the sound signals received by the microphone.

3. The communications device of claim 1, wherein if the volume adjusting module determines that the second sound intensity of the sound signals received by the communication unit is greater the first sound intensity of the sound signals received by the microphone, the volume adjusting module decreases the volume of the sound signals received by the communication unit to a second preset value which is less than or equal to the first sound intensity of the sound signals received by the microphone.

4. A volume adjusting system applied in a communications device, the communications device comprising a microphone to collect sound signals, a communication unit to communicate the communications device with at least one other communications device and to receive sound signals from the at least one other communications device, a processor, and a storage device, the system comprising:
a sound intensity detecting module, stored in the storage device, comprising at least one instruction configured to cause the processor to detect a first sound intensity of sound signals collected by the microphone, and detect a second sound intensity of sound signals received by the communication unit when a speech communication being established between the communications device and the at least one other communications device; and
a volume adjusting module, stored in the storage device, comprising at least one instruction configured to cause the processor to compare the first sound intensity of the sound signals collected by the microphone and the second sound intensity of the sound signals received by the communication unit, adjust a volume of the sound signals received by the communication unit according to a comparison result of the first sound intensity and the second sound intensity, and output the sound signals has been adjusted by the processor to users.

5. The volume adjusting system of claim 4, wherein if the volume adjusting module determines that the second sound intensity of the sound signals received by the communication unit is less than the first sound intensity of the sound signals received by the microphone, the volume adjusting module increases the volume of the sound signals received by the communication unit to a first preset value which is greater than or equal to the first sound intensity of the sound signals received by the microphone.

6. The volume adjusting system of claim 4, wherein if the volume adjusting module determines that the second sound intensity of the sound signals received by the communication unit is greater the first sound intensity of the sound signals received by the microphone, the volume adjusting module decreases the volume of the sound signals received by the communication unit to a second preset value which is less than or equal to the first sound intensity of the sound signals received by the microphone.

7. A volume adjusting method applied in a communications device, the communications device comprising a microphone, a communication unit configured for signal communication with at least one other communications device, a processor, and a storage device, the method comprising:
detecting a first sound intensity of sound signals collected by the microphone, and detecting a second sound intensity of sound signals received by the communication unit by a processor when a speech communication is established between the communications device and the at least one other communications device;
comparing the first sound intensity of the sound signals collected by the microphone and the second sound intensity of the sound signals received by the communication unit by the processor; and
adjusting a volume of the sound signals received by the communication unit by the processor according to a comparison result of the first sound intensity and the second sound intensity.

8. The volume adjusting method of claim 7, wherein the method of “adjusting a volume of the sound signals received by the communication unit according to a comparison result of the first sound intensity and the second sound intensity” comprising:
if determining that the second sound intensity of the sound signals received by the communication unit is less than the first sound intensity of the sound signals received by the microphone, increasing the volume of the sound signals received by the communication unit to a first preset value which is greater than or equal to the first sound intensity of the sound signals received by the microphone.

9. The volume adjusting method of claim 7, wherein the method of “adjusting a volume of the sound signals received by the communication unit according to a comparison result of the first sound intensity and the second sound intensity” comprising:
if determining that the second sound intensity of the sound signals received by the communication unit is greater than the first sound intensity of the sound signals received by the microphone, decreasing the volume of the sound signals received by the communication unit to a second preset value which is less than or equal to the first sound intensity of the sound signals received by the microphone.

10. The volume adjusting method of claim 7, further comprising:
outputting the sound signals after adjustment of same by the processor via a loudspeaker.
